(19) United States
(12) Patent Application Publication
(10) Pub. No.: US 2025/0291604 A1
(43) Pub. Date: Sep. 18, 2025

(54) ARCHITECTURE FOR MICROCONTROLLER-BASED PLUG AND PLAY EDGE AI USB CAMERA

(71) Applicant: e-con Systems India Private Limited, Chennai (IN)

(72) Inventors: K. Ramson Jehu, Chennai (IN); Abisheik Sivakumar, Chennai (IN); A. Arun, Chennai (IN)

(21) Appl. No.: 18/602,119

(22) Filed: Mar. 12, 2024

(51) Int. Cl. G06F 9/4401; G06F 13/10; G06F 13/40

(52) U.S. Cl. CPC G06F 9/4411; G06F 13/102; G06F 13/4081; G06F 2213/0042

(57) ABSTRACT

A system of USB communicating camera comprising an integrated USB camera further comprising a USB communicating camera with a sensor, an image signal processor and integrated with a microcontroller having an image processing module, an inference unit, a first USB interface, a flash memory; a host system with a processor, a user interface application and a second USB interface to communicate to and from the USB communicable camera, the system is user configurable for different application specific pre-trained machine learning models. The user interface application is adapted to receive an application specific configuration data. The inference unit is an artificial intelligence inference unit that draws inference on image frames based on an input and the corresponding pre-trained machine learning model. The system deploys edge computing. A firmware residing in the flash memory remains unchanged when different application specific pre-trained machine learning models are loaded in the flash memory.

### FIELD OF THE INVENTION

The present invention relates an architecture around a USB camera for a plurality of trained models without the need for building firmware for respective trained models. Particularly, the present invention relates to a configuration and inference architecture around an edge AI based USB camera.

### BACKGROUND OF THE INVENTION

USB cameras have attained a dominant position in the world of videography and photography. Concurrently, artificial intelligence continues to intervene to replace human intelligence to an increasing degree.

US20230186636A1 teaches an edge computing system deployed at a physical location and receives an input from one or more image/video sensing mechanisms. The edge computing system executes artificial intelligence image/video processing modules on the received image/video streams and generates metrics by performing spatial analysis on the images/video stream. The metrics are provided to a multi-tenant service computing system where additional artificial intelligence (AI) modules are executed on the metrics to execute perception analytics. Client applications can then be run on the output of the AI modules in the multi-tenant service computing system. Here, the camera and edge computing system are two separate entities. These edge computing systems might be one or more processor or servers. Processors are known to process relatively large data with a minimum scan time and are therefore generally slower yet more expensive for a specific action.

US20220198774A1 is specific to person-pose detection model and discusses cropping the region of interest based on the output from the model which is then transmitted for live feed. A processor is used having an operating system, and such hardware architecture does not require a firmware.

US20230245433A1 discloses a hybrid machine vision model, wherein a conventional computer vision (CV) algorithm is run whose output is given to the model and the final output is considered. It can also be a sequence of multiple CV algorithms and models, running on processor.

US20210360201A1 discloses a system that runs on microcontroller and uses a standalone device to get frame and runs a machine learning model on it, the standalone device communicating on wireless radio connectivity. If the model needs to be updated, then corresponding firmware must be sent to the device and it should be updated.

Some of the above discussed solutions deploy a USB camera while artificial intelligence resides in a PC or a host computer comprising a processor. Some such current solutions require the model to be included in the firmware and built using the corresponding IDE and then flash the firmware onto the device. In other words, such solutions are model specific.

Importantly, none of the prior art address possibility of changing the model. Thus a system would be efficient for say face detection but not suitable for defect detection in an industry, without sacrificing on simplicity to be able to change the model. A known method to address such requirement is to change the firmware.

It is important to note that current processor-based solutions don't generally require a firmware while current controller based solution require a firmware. A processor generally runs on an operating system which has file system, process management system, task management, etc. So, if it is needed to change the model, one can stop the current machine learning task and, copy the model from PC to processor's file system directly and start another machine learning task that calls the new model file. In case of microcontrollers, there is no file system and no process management system. For task management, to an extent there are real-time operating system (RTOS) which would run on microcontrollers. Once the device is started, there is no option to stop the current task from running. Since there is no file system, new model cannot be directly copied from pc to device and the firmware needs to change.

Currently, in systems with microcontroller, the model file is included as a source file in the firmware code. This firmware code is build using IDE to generate a firmware bin file and flashed onto the device. When the model change is to be carried out, one needs to again build the firmware code and generate bin file and flash it onto the device.

In this solution therefore, the user cannot use the device as a plug and play and cannot change the model at will, unless the user re-builds the firmware. Re-building requires setting up a build environment, erasing the complete firmware and flashing the new firmware, which is a skill based and time taking process and the system is not ready nor suitable for versatile applications without firmware updation. Firmware building is a development activity which is not a user activity/user friendly activity. Our solution bridges this industrial gap. Our solution can configure the USB camera which can be used in machine learning lifecycle namely dataset collection, model deployment and model inferencing.

### SUMMARY OF INVENTION

The present invention deploys a USB camera with integrated artificial intelligence modules, and such AI integrated USB camera is deployable with any contemporary personal computer (PC), termed here a host computer. Through a USB interface module, the AI integrated USB camera of the present invention is capable of receiving application specific pre-trained model along with a configuration file from the host computer and sends back image frame and corresponding inference data. Inference implies assessing an image frame or a plurality as per artificial intelligence extractable from a pre-trained machine learning model. Edge computing is deployed for faster analysis, real-time decision-making, and reduced reliance on external resources. The application specific-pre-trained model is changeable without firmware change, and this feature is the essence of the present invention making it a true plug-and-play architecture. The firmware is coded for catering to generic and common aspects of a prescribed group of pre-trained models of applications while custom aspects of such applications are configurable by user via drop-down menus. Further, several configuration settings are pre-set at a default value to facilitate a user having to select and configure only when necessary and not necessarily always.

The integrated USB camera is an integration of:
An image acquisition block
A microcontroller
A flash memory

The host computer comprises a user interface application driven by a configuration and inference computer program. The host computer further comprises a processor and a second USB interface.

The image acquisition block has a sensor and an image signal processor. The microcontroller has an image processing module, an AI inference unit and a first USB interface. An inference data resides in a non-volatile memory of the microcontroller. A prescribed pre-trained model, a configuration file and a firmware reside in the flash memory.

Each configuration file is specific to a specific application and a corresponding pre-trained model, and the AI inference unit of the integrated USB camera operates accordingly and generates inferences.

The system of the USB communicating camera as per present invention is user friendly as an updated firmware need not be flashed on the microcontroller when different machine learning model needs to be deployed. Instead, the flash memory of the integrated USB camera has a firmware residing therein that supports different application specific pre-trained machine learning models with correspondingly different configuration data co-residing therein. A model specific data is updated in the configuration mode in the host computer and flashed to the flash memory to be able to execute the corresponding specific model in the AI inference unit residing in the microcontroller of the integrated USB camera and in the inference mode, the inference data, essentially in the form of humanly uninterpretable data packets or in the form of a raw model output is communicated back to the host computer for a meaningful post processing.

A configuration and inference computer program as per the present invention resides in the microcontroller and the processor, while a human interface resides in the processor of the host computer. In the configuration mode, the integrated USB camera is configured via the host computer with the required configuration details through the user interface application. The protocol buffer (protobuf) file containing all the configurations is created in the host computer and then written to the flash memory of the integrated USB camera. Along with that the pre-trained model file is also written on to the flash memory of the integrated USB camera. The integrated USB camera is reset or rebooted to cause changes made to be active. In Inference mode, the model will inference an image frame and the output will be sent to the host using the HID interface.

In the configuration mode, the integrated USB camera is prepared for a specific pre-trained ML model.

In the configuration mode, user sets up a streaming format of the integrated USB camera including a resolution and a video format. The system has a default resolution. The custom resolutions are pre-set which can be previewed. User can configure custom resolutions, model details, generate config file and load them. In the preferred embodiment, custom resolutions 1 & 2 can be configured by the user based on the requirements. By default, these values are 960×960p and 320×320p, Y8 at 12 fps.

User selects the video formats (303) from a drop-down menu, wherein options include UYVY (YUV 4:2:2) and Y8.

User can select a region of interest (ROI) for this resolution using the graphical user interface (GUI) tool. When selecting the ROI Width & ROI Height and the resolution width & the resolution height, users may make sure both have the same aspect ratio. If they are different, however, then the integrated USB camera takes the aspect ratio of custom resolution 1 from the selected ROI.

User edits to generate an updated configuration to generate an appropriate config. file, after all the configuration parameters are set as well as previewed.

This file is user readable and editable Protobuf file which represents the configuration made by the user. The data in this file is used to configure the camera for inferencing an application specific pre-trained model. User can select the Path in which the file must be generated using the Path button.

A configuration file can also be generated without uploading any model. Such situation sets up custom resolution 1 to the preview_roi values and the custom resolution 2 becomes default 320×320 pixels or user selected custom resolution (using custom input option in model input size). For the inference to run on the USB communicable camera, however, the configuration file needs to have the model data values.

Once the model is loaded using the load model tab, write model will write the model onto the camera, which will be used for inferencing. The Read Config menu will list the current configuration present in the device.

User selects the inference mode to get desired outcome as per prescribed pre-trained model uploaded in the configuration mode through the operational loop running in the microcontroller. Once user starts inference process, the USB communicable camera starts inferencing the image frames and gives out raw model output to the application.

A pre-processing is carried out in the integrated USB camera.

The saved output is the raw model output from the integrated USB camera. In a preferred embodiment, it is a python list of output tensors.

On starting inference mode, the integrated USB camera starts inferencing the image frame(s) and gives out the raw model output to the user interface application.

The post processing of model implies a user interpretable output created out of intelligent but non-readable data. Post processing varies from model to model. To overlay the raw model output with a post processing framework on the preview the output gets post processed into meaningful data such as bounding boxes, labels, scores. The raw model output from the USB communicable camera is given to a selected post processing module and overlayed by bounding boxes, labels, scores according to the task, illustratively Detection, Regression, Classification.

By “enable overlay” option applied on any selected file of the raw model output, user can draw a visual overlay on the host computer that is based on the outputs of the loaded model, utilizing a post-processing script. This inventive feature as per the present invention which is elaborately configurable is particularly useful in verifying the accuracy and usability of the model in its target environment. With the overlay, user can see the model's detections in real-time. This way, user can ensure that the model meets specific needs and requirements.

Customized post-processing module allows users to overlay the model output of one's own model with the user interface application of the system.

### BRIEF DESCRIPTION OF DRAWINGS

FIG. 1 is an architecture diagram of a system of a universal serial bus (USB) communicating plug and play camera as per present invention.

FIG. 2 is a hardware block diagram of an integrated USB camera of the system.

FIG. 3 is an operational logic diagram of the system as per present invention.

FIG. 4A-4B is a comparative tabulation of configuration parameters for two illustrative applications.

FIG. 5A-5B is a logic diagram of a configuration mode of the system.

FIG. 6 is a tabulation of video formats and camera resolutions of the present invention.

FIGS. 7, 8, 9 are screen displays of the configuration mode.

FIG. 10 is a tabulation of channels options specific to pe-trained machine learning models.

FIG. 11 is a screen display of a region of interest.

FIG. 12 is a tabulation of aspect ratios of the region of interest.

FIGS. 13, 14, 15, 16 are further screen displays of the configuration mode.

FIG. 17A-17C is a logic diagram of an inference mode of the system.

FIG. 18 is a screen display of the inference mode.

FIG. 19 is an illustrative inference data of a raw model output.

FIG. 20, 21A, 21B are further screen displays of the inference mode.

FIG. 22 is a screen display of overlay in the inference mode.

FIG. 23, 24 are further screen displays of the inference mode.

FIG. 25 is an architecture diagram of a microcontroller integrated in the system as per the present invention.

FIG. 26 is an architecture diagram of a processor of the host computer.

### DETAILED DESCRIPTION OF THE INVENTION

The present invention shall now be described with the help of accompanying drawings. It is to be expressly understood that several variations are possible around the inventive concept disclosed and the description should not be construed to limit the invention in any manner whatsoever except by the claims which follow.

Terms inference data and raw model output are used interchangeably in Figures and description.

The present invention deploys a USB camera with integrated artificial intelligence modules, and such AI integrated USB camera is deployable with any contemporary personal computer (PC) or a host computer. Through a USB interface module, the AI integrated USB camera of the present invention is capable of receiving application specific pre-trained model along with a configuration file from the host computer and sends back image frame and corresponding Inference data.

Inference implies assessing an image frame or a plurality of image frames and includes a video, as per artificial intelligence, as per requirement, such objective inference being extractable by deploying a pre-trained machine learning model in the present invention. Illustratively, defect in a product can be inferenced through its image frame based on machine learning of a pre-trained model. Face detection, personnel presence are likewise carried out.

Edge computing is deployed for faster analysis, real-time decision-making, and reduced reliance on external resources. The application specific-pre-trained model is changeable without firmware change, and this feature is the essence of the present invention making it a true plug-and-play architecture. The firmware is coded for catering to common aspects of a prescribed group of pre-trained models of applications while custom aspects of such applications are configurable by user via drop-down menus. Further, several configuration settings are pre-set at a default value to facilitate a user having to select and configure only when necessary and not necessarily always.

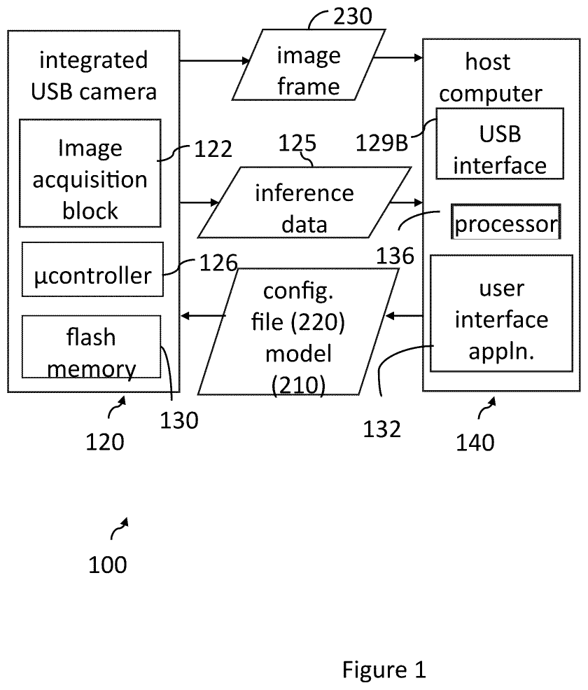

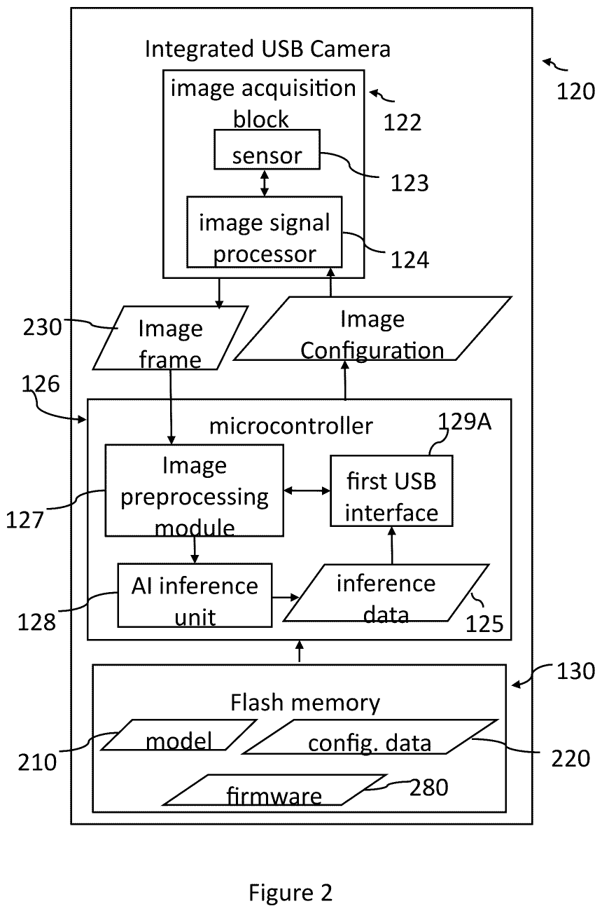

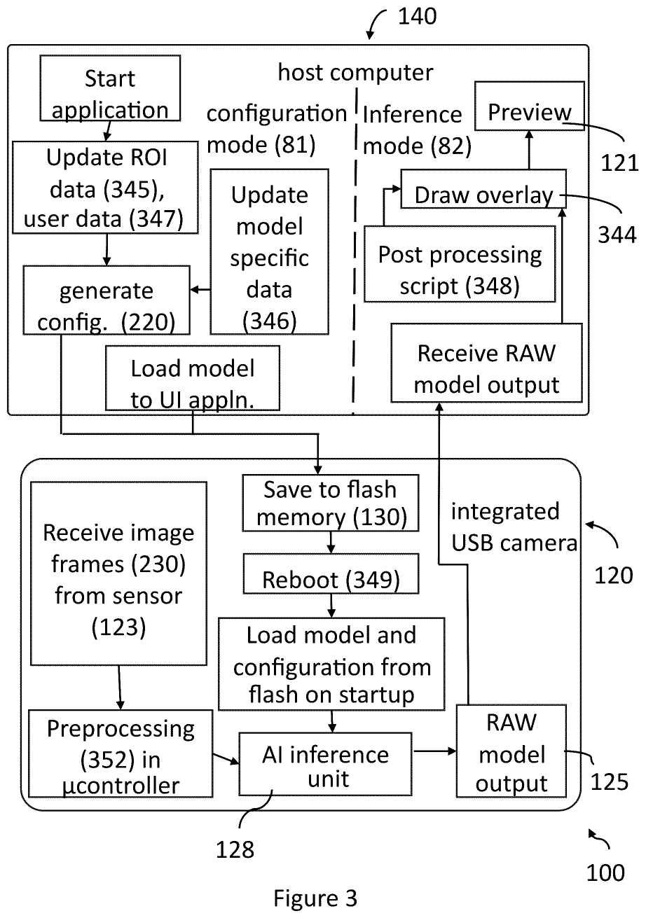

AI integrated USB camera is hereinafter termed as integrated USB camera. Accordingly, FIG. 1, 2, 3, the present invention is a camera system (100) comprising an integrated USB camera (120) and a host computer (140). The camera system (100) has two modes—
1. A Configuration mode (81) and
2. An Inference mode (82)

The two modes are further described in detail below.

The integrated USB camera (120) is an integration of:
An image acquisition block (122)
A microcontroller (126)
A flash memory (130)

The host computer (140) comprises a user interface application (132) driven by a configuration and inference computer program. The host computer (140) further comprises a processor (136) and a second USB interface (129B).

The image acquisition block (212), a sensor (123) and an image signal processor (124). The microcontroller (126) has an image processing module (127), an AI inference unit (128) and a first USB interface (129A). An inference data (125) resides in a non-volatile memory of the microcontroller (126). A prescribed pre-trained model (210), a configuration file (220) and a firmware (280) reside in the flash memory (130).

Each configuration file (220) is specific to a specific application and a corresponding pre-trained model (210), and the AI inference unit (128) of the integrated USB camera (120) operates accordingly and generates inferences.

The system of the USB communicating camera (100) as per present invention is user friendly as an updated firmware need not be flashed on the microcontroller (126) when different machine learning model needs to be deployed. Instead, the flash memory (130) of the integrated USB camera (120) has a firmware (280) residing therein that supports different application specific pre-trained machine learning models with correspondingly different configuration data co-residing therein. A model specific data is updated in the configuration mode (81) in the host computer (140) and flashed to the flash memory (130) to be able to execute the corresponding specific model (210) in the AI inference unit (128) residing in the microcontroller (126) of the integrated USB camera (120) and in the inference mode (82), the inference data (125), essentially in the form of humanly uninterpretable data packets or in the form of a raw model output is communicated back to the host computer (140) for a meaningful post processing.

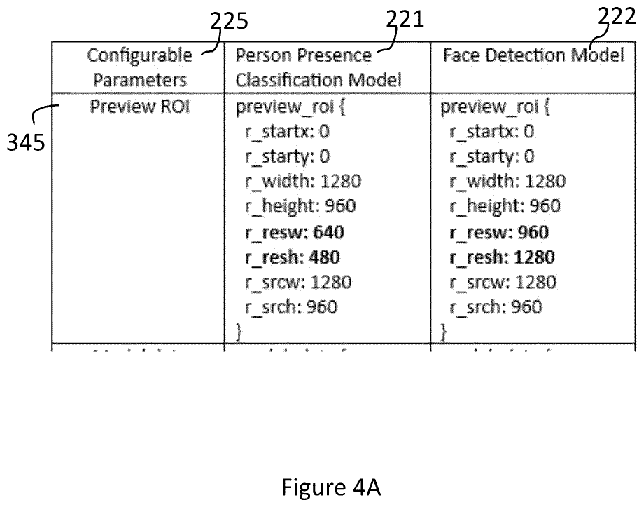

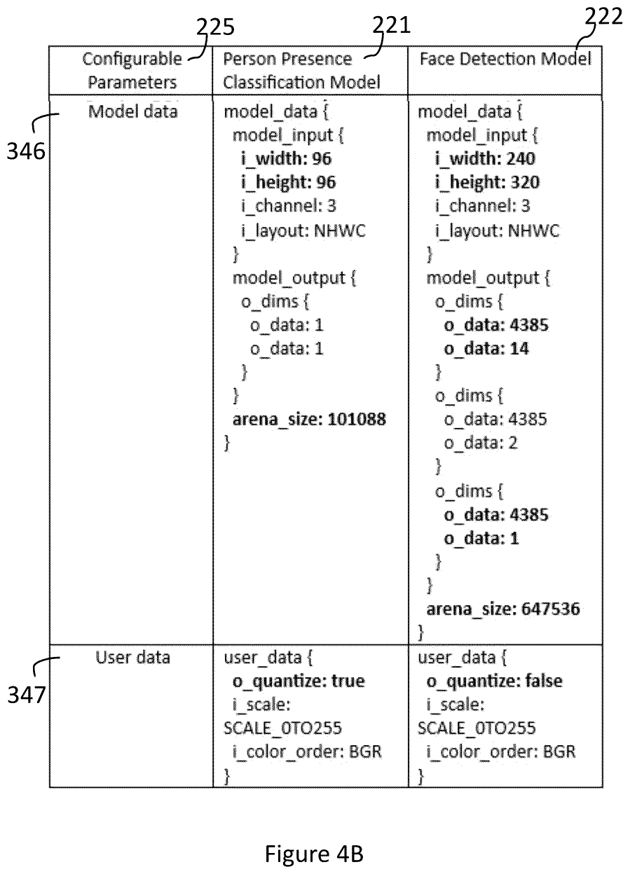

FIGS. 4A and 4B, configuration parameters (225) for two illustrative applications-a person presence classification model (221), and a face detection model (222), is differentially compared. The person presence classification model (221) generally inferences a yes or no binary answer 1 or 0 respectively to indicate presence or absence of any person. The face detection model (222), on the other hand inferences co-ordinates of a requisitioned face in a region of interest (ROI).

Thus, the preview_roi (345) contains settings related to the preview (121) of the region of interest (ROI). The r_startx and r_starty parameters determine the starting point of the ROI, while the r_width and r_height parameters determine the width and height of the ROI respectively. The r_resw and r_resh parameters determine the resolution of the preview frame (custom resolution 1), while the r_srcw and r_srch parameters determine the width and height of the source video stream (which is always constant 1280*960).

This ROI should be selected by the user based on the requirement of their use case application. This value is used for configuring the sensor & image signal processor (ISP). Usually, these values are hard coded in the firmware code so that during startup, these values are set in the sensor & ISP. With our inventive architecture, these specific values are stored in the flash memory and are fetched during startup and the sensor and the image signal processor are configured accordingly.

The model_data (346) contains settings related to the model input and output dimensions. The i_width, i_height, and i_channel parameters determine the input width, height, and number of channels respectively. The i_layout parameter determines the input layout type, either NHWC or NCHW. The o_dims parameter determines the output dimensions of the model.

The user_data (347) contains settings related to the user data that will be processed by the model. The o_quantize parameter determines whether the model output will be quantized. The i_scale parameter determines the normalization type of the input data. The i_color_order parameter determines the order of the color channels (RGB or BGR) in the input data.

A protocol buffer (protobuf) file that associates data types with field names, using integers to identify each field instead of field names, is deployed for faster configuration. An illustrative protobuf file is as below:

```
syntax = “proto2”;
message CustomPreview {
  required int32 r_startx = 1 [default = 0];
  required int32 r_starty = 2 [default = 0];
  required int32 r_width = 3 [default = 1280];
  required int32 r_height = 4 [default = 960];
  required int32 r_resw = 5 [default = 960];
  required int32 r_resh = 6 [default = 960];
  required int32 r_srcw = 7 [default = 1280];
  required int32 r_srch = 8 [default = 960];
}
message ModelInput {
  enum Layout {
    NHWC = 0;
    NCHW = 1;
  }
  required int32 i_width = 1 [default = 320];
  required int32 i_height = 2 [default = 320];
  required int32 i_channel = 3 [default = 1];
  optional Layout i_layout = 4 [default = NHWC];
}
message ModelOutput {
  message Dims{
    repeated int32 o_data = 1;
  }
  repeated Dims o_dims = 1;
}
message ModelMetaData {
  enum Engine{
    TFLM = 0;
    RTM = 1;
  }
  required ModelInput model_input = 1;
  optional ModelOutput model_output = 2;
  optional uint32 arena_size = 3;
  optional Engine inf_engine = 4;
}
message UserDefinedData {
  enum Scale {
    SCALE_0TO255 = 0;
    SCALE_0TO1 = 1;
    SCALE_NEG1TO1 = 2;
    SCALE_NEG128TO127 = 3;
  }
  enum ColorOrder {
    RGB = 0;
    BGR = 1;
  }
  optional bool o_quantize = 1 [default = false];
  optional Scale i_scale = 2 [default = SCALE_0TO255];
  optional ColorOrder i_color_order = 3 [default = RGB];
}
message CameraConfig {
  required CustomPreview preview_roi = 1;
  optional ModelMetaData model_data = 2;
  optional UserDefinedData user_data = 3;
}
```

As is evident, the protocol buffer format is human readable and therefore easily editable.

A computer program as per the present invention resides in the microcontroller while a human interface resides in the Host computer. In the configuration mode (81), the integrated USB camera (120) is configured via the host computer (140) with the required configuration details through the user interface application (132). The protocol buffer (protobuf) file containing all the configurations is created in the host computer (140) and then written to the flash memory (130) of the integrated USB camera (120). Along with that the pre-trained model file (210) is also written on to the flash memory (130) of the integrated USB camera (120). The integrated USB camera (120) is reset or rebooted (349) to cause changes made to be active. In Inference mode (82), the model (210) will inference an image frame (230) and the output will be sent to the host using the HID interface.

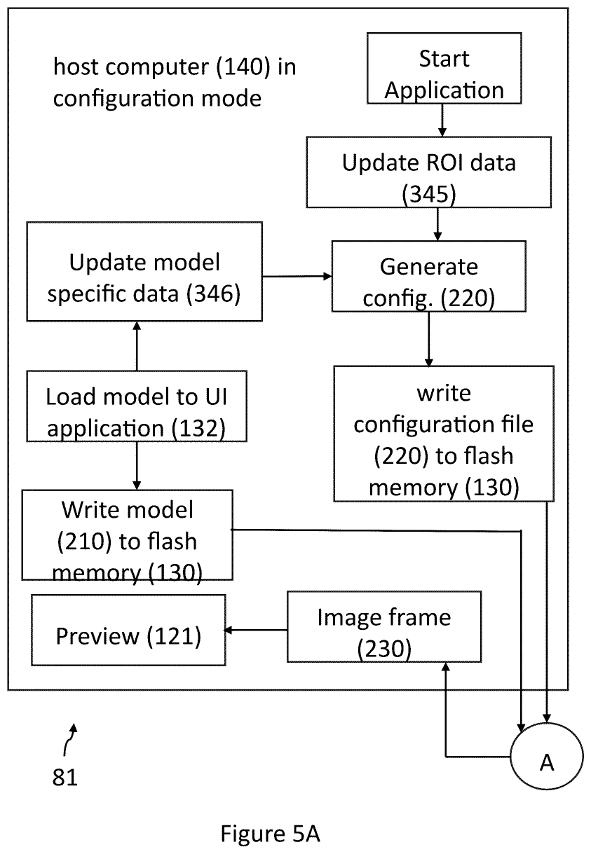

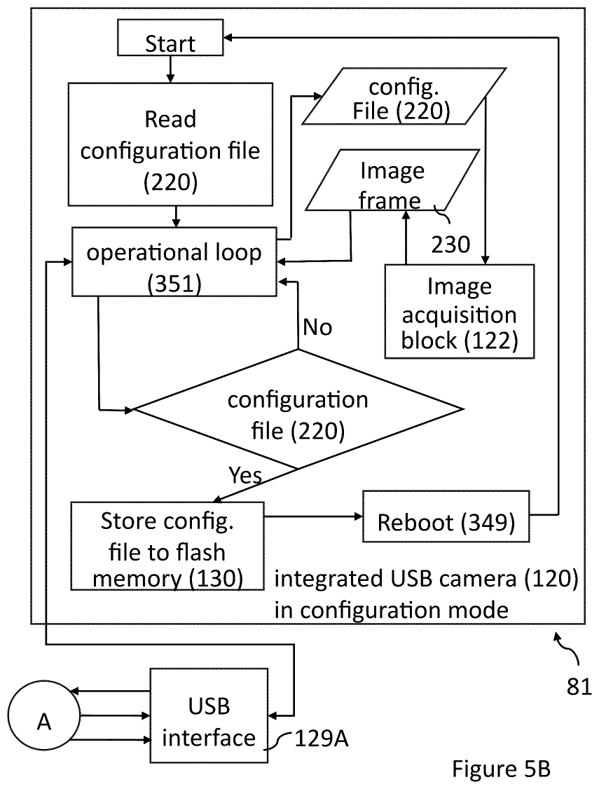

FIGS. 5A-5B referred in continuation, in the configuration mode (81) the integrated USB camera (120) and the host computer (140) are prepared for a specific pre-trained model (210) through an operational loop (351) running in the microcontroller (126) of the integrated USB camera (120). The steps are explained below through screen displays of the user interface application (132) of an configuration and inference computer program.

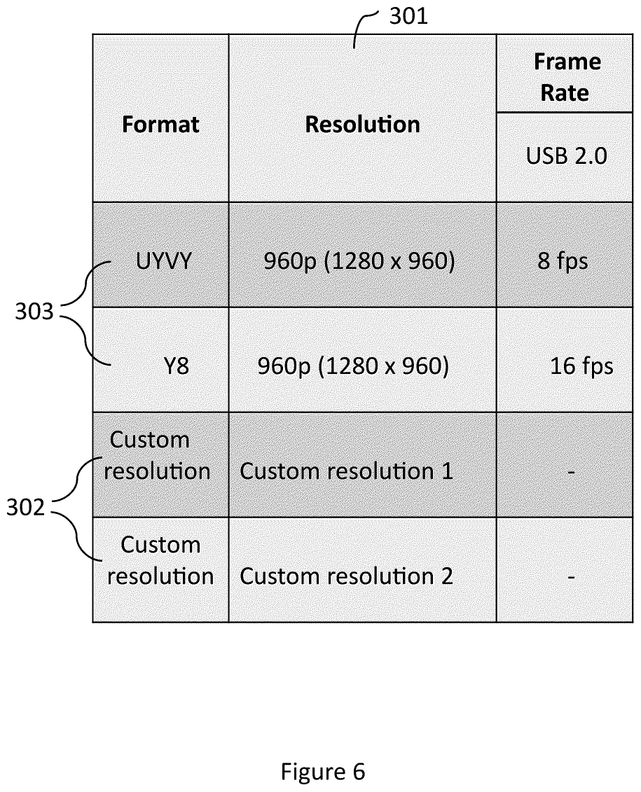

The configuration mode (81), user sets up a streaming format of the integrated USB camera (120) including a resolution (301) and a video format (303). The system (100) has a default resolution. FIG. 6, the custom resolutions are pre-set which can be previewed. User can configure custom resolutions (302), model details, generate config file and load them. In the preferred embodiment, custom resolutions 1 & 2 can be configured by the user based on the requirements. By default, these values are 960×960p and 320×320p, Y8 at 12 fps.

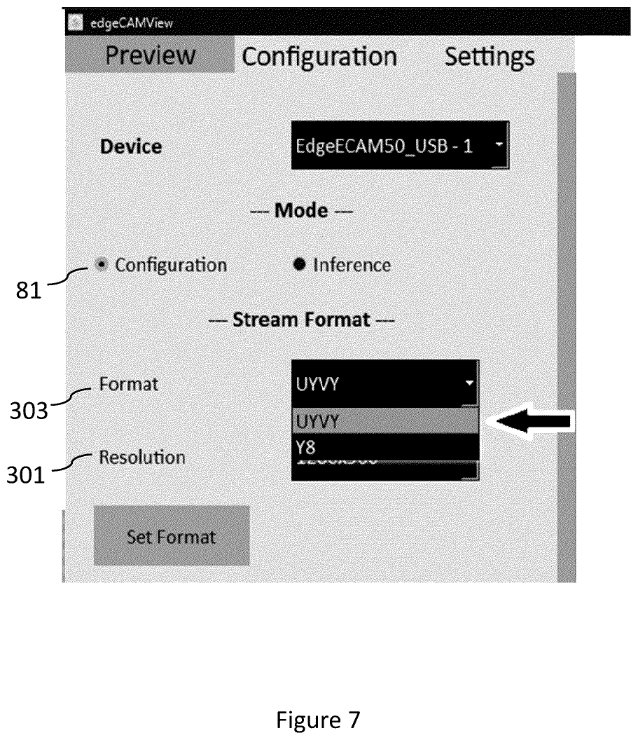

FIG. 7, user selects the video formats (303) from a drop-down menu, wherein options include:
UYVY (YUV 4:2:2)
Y8

By default, YUYV (YUYV 4:2:2) preview option is selected. The Y's represent luminance (that is black and white information) while U and V represent colour information.

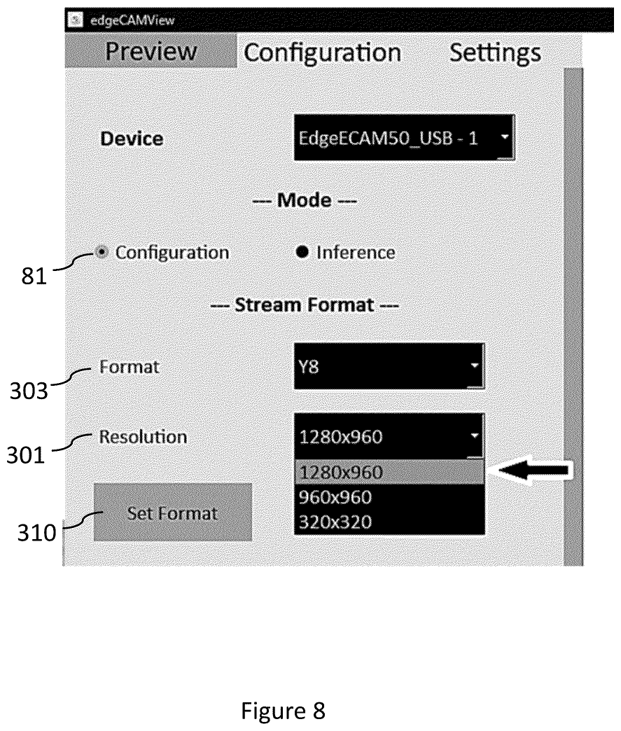

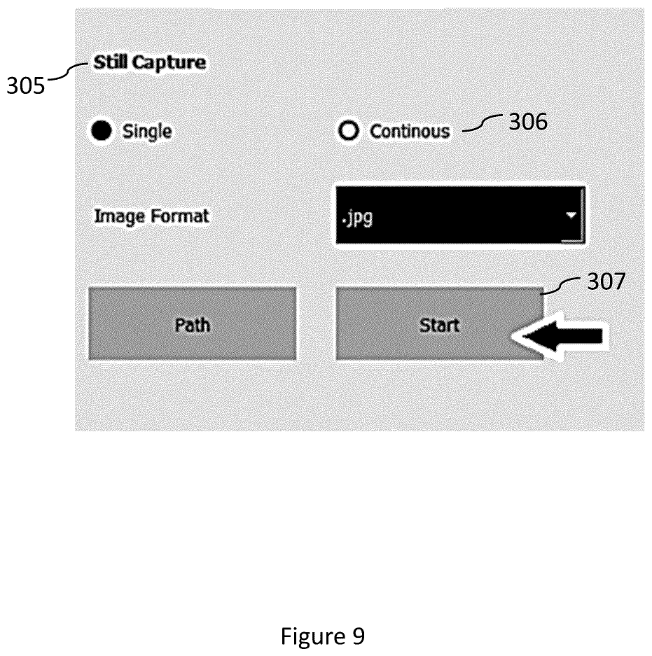

FIG. 8, to change the preview size, user can select the preview resolution from the resolution drop-down menu. After selecting the desired format and resolution, user clicks set format (310) to set the selected the video format (303) and the resolution (301). The camera preview would change automatically as per selected format and resolution, and user can view the output fps. FIG. 9, the still capture (305) option is selectable, wherein users choose from formats including Portable Network Graphic (PNG), Joint Photographic Experts Group (JPG), and RAW. If user selects continuous (306) mode option and clicks start (307), the capturing of frames continuously is triggered at a prescribed interval until user clicks stop. This image capture feature is useful in collecting the dataset from the camera for training the machine learning model (210).

The architecture as per present invention provides options to configure some of the parameters generally required for the integrated USB camera (120). The parameters configurable in the preferred embodiment are listed below:
Custom resolution 1
Custom resolution 2, setting model's input resolution with Field of View (FOV) scaled down from Custom resolution 1
User Data
Inferencing

Custom resolution 1 allows users to modify the resolution of their camera output to suit purpose, providing freedom to set or limit the Field of View (FOV) in different scenarios, enabling to capture relevant activity without wasting bandwidth and computational resources on areas that are not required.

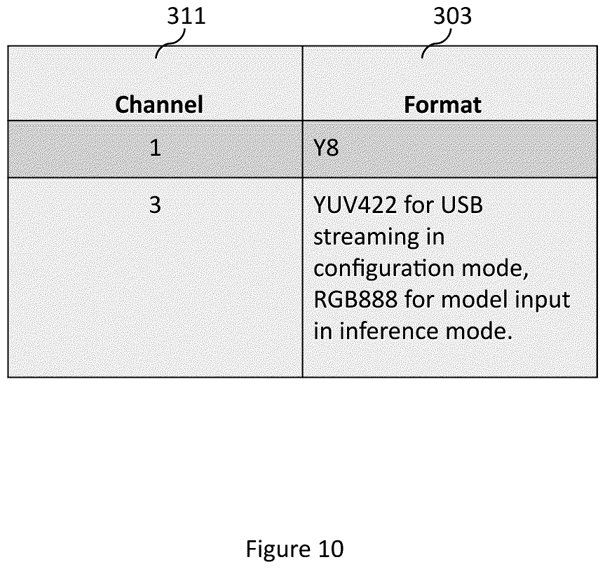

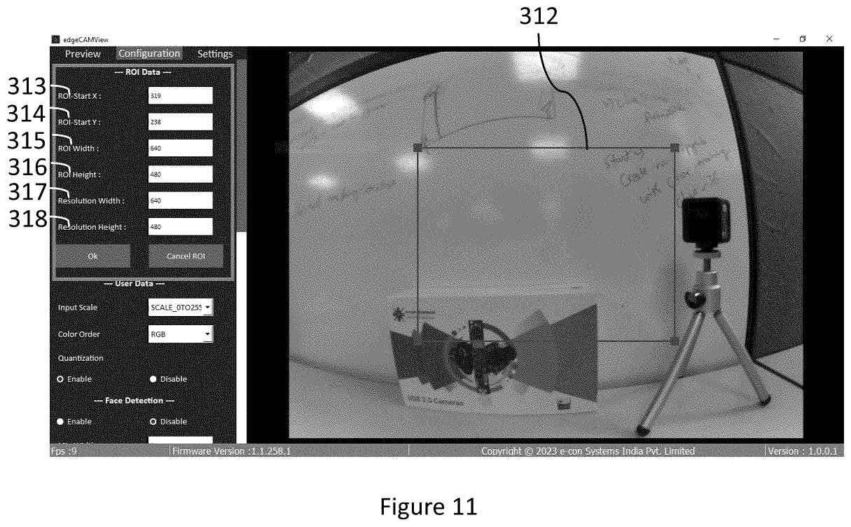

FIG. 10, a channel (311) represents an input format for the model. The possible channels are 1 and 3. Custom resolution 1 can be modified in either UYVY or Y8 video formats (303), depending on the model's input format. FIG. 11, user can select a region of interest (ROI) (312) for this resolution using the graphical user interface (GUI) tool. The steps to set custom resolution 1 are as follows:
1. Selecting the ROI (312) in the graphical user interface (GUI) by clicking & dragging the mouse in the preview (121). Selected ROI coordinates will be displayed in the text boxes such as Start X (313), Start Y (314), ROI width (315) and ROI height (316). These values can also be entered by the user.
2. Entering a resolution width (317) and a resolution height (318). This will be the custom resolution 1 which will be enumerated in the USB camera.
The selected ROI will be scaled to the entered resolution width (317) and resolution height (318).

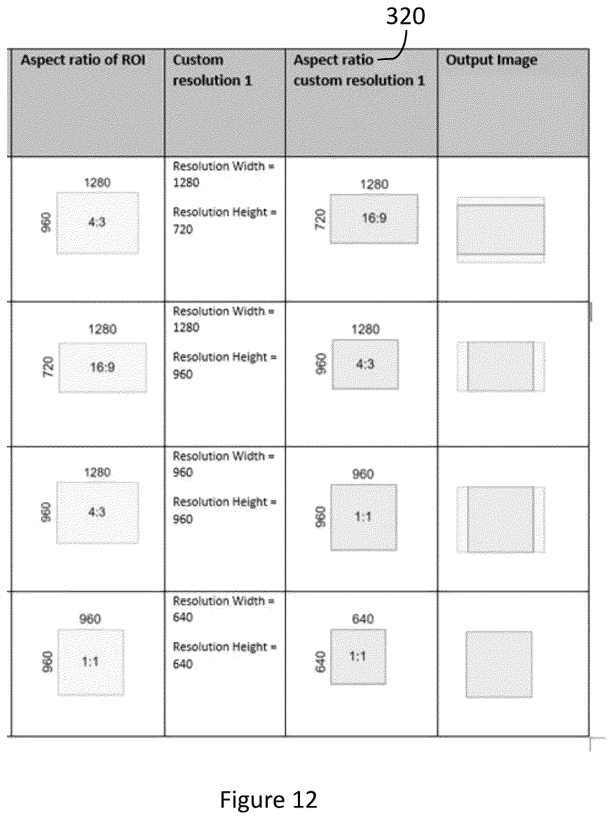

FIG. 12, when selecting the ROI Width (315) & ROI Height (316) and the resolution width (317) & the resolution height (318), users may make sure both have the same aspect ratio. If they are different, however, then the integrated USB camera (120) takes the aspect ratio (320) of custom resolution 1 from the selected ROI (312).

Custom resolution 2 is actual input in which the model is going to inference. It is another resolution which user can modify. The purpose of custom resolution 2 is to give user a preview (121) of what will be given as input to the machine learning model in inference mode. Custom resolution 2 is a scaled down version of Custom resolution 1. The field of view (FOV) for both is same.

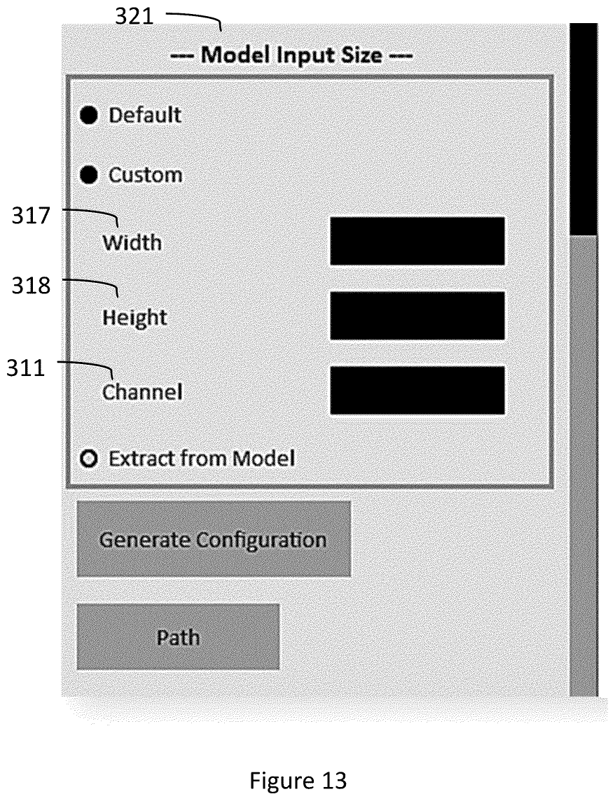

FIG. 13, a model input size (321) menu determines the resolution and format of custom resolution 2. The resolution width (317) and the resolution height (318) represent the dimensions of the resolutions and the channel (311) represents the input format for the model. The possible channels are 1 and 3. If the model input size (custom resolution 2) is selected as odd resolution, the USB communicable camera streams the next possible even resolution in configuration mode. Illustratively, for a selected size of 321×321, the USB communicable camera streams a size of 322×322 in configuration mode. In inference mode, however, the 321×321 will be given to the model.

In the preferred embodiment, there are three ways to assign this value in model input size.
Default
Custom
Extract from Model

When “extract from model” option is selected, the application will extract the model's input size which will be set as custom resolution 2.

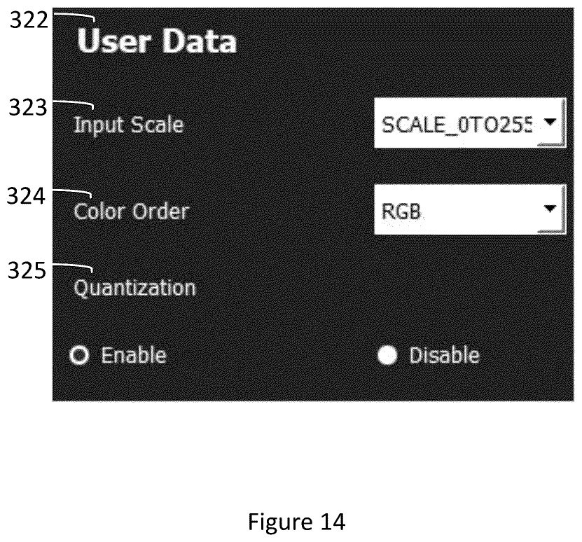

FIG. 14, the controls of user data (322) options in the present invention are as follows:
Input Scale (323)
Colour Order (324)
Quantization (325)

Input Scale (323) option enables scaling of input image data given to the model at inference, to different scales like 0 to 255, 0 to 1, −1 to 1 and −128 to 128. This scale should be similar to the scale at which the model was trained, so that the data distribution remains the same during inference as well.

If three channel model is used, the input image's colour order might differ based on how the model is trained. The option of color order (324) converts the image frame (230) from the sensor (123) to the selected RGB or BGR colour order before feeding into the model.

Quantization (325) is known for optimization of a deep learning network deployment for real-time inference as it significantly reduces the cost of communicating with respect to the cloud in terms of network bandwidth, network latency, and power consumption. In the present invention however, this known benefit is of no direct relevance since we are NOT communicating with any network! The present invention deploys quantized model for reducing latency in computing, besides saving memory, particularly since the edge device, which is the integrated USB camera (120) in the present invention, has a limited memory, computing resources, and power.

If int8 or uint8 quantized model are used, enabling this option dequantizes the model output to float32 using the output quantization parameters present in the model.

User edits to generate an updated configuration to generate an appropriate config. file, after all the configuration parameters are set as well as previewed.

This file is user readable and editable Protobuf file which represents the configuration made by the user. The data in this file is used to configure the camera for inferencing an application specific pre-trained model. User can select the Path in which the file must be generated using the Path button.

A configuration file (220) can also be generated without uploading any model. Such situation sets up custom resolution 1 to the preview_roi values and the custom resolution 2 becomes default 320×320 pixels or user selected custom resolution (using custom input option in model input size).

For the inference to run on the USB communicable camera, however, the configuration file (220) needs to have the model data values.

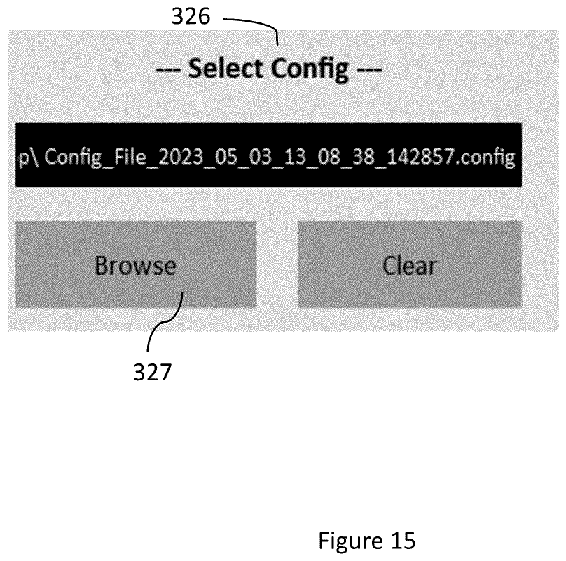

FIG. 15, user uses option to select configuration (326). The generated config file is automatically selected when generate configuration is selected. If the user wishes to load configuration from any of the previously generated config file, user selects a particular config file using the browse (327) option.

User can select Write Configuration menu. After generation of config file, selecting Write Config will write the configuration from the .config file onto the camera. This resets the device to put the configuration into effect.

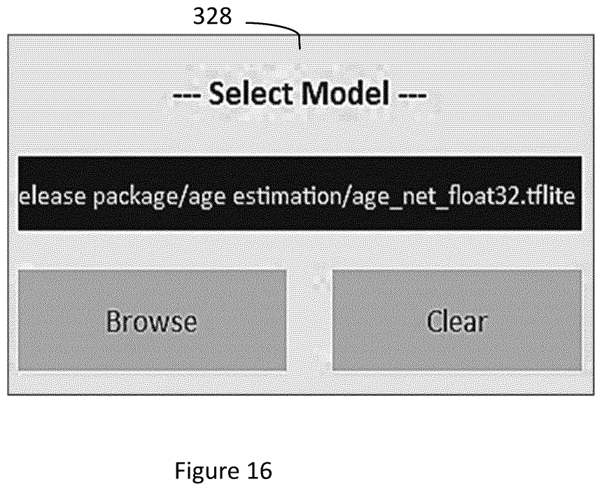

FIG. 16, user picks select model (328) option. The selected model must be compatible with TFLite Micro framework. The size of the model, model input size, arena size required for the model will be validated based on the limits previously specified. If any of the limitations are exceeded, the model cannot be loaded. The user will receive the warning for the corresponding limitation.

If the model is loaded successfully, the model input size will be switched to load from model option automatically and take the model input size from the model. This is done in-order to set the custom resolution 2 to the size of the model input size. Since this is the resolution in which the model is going to inference.

Once the model is loaded using the load model tab, write model will write the model onto the camera, which will be used for inferencing. The Read Config menu will list the current configuration present in the device.

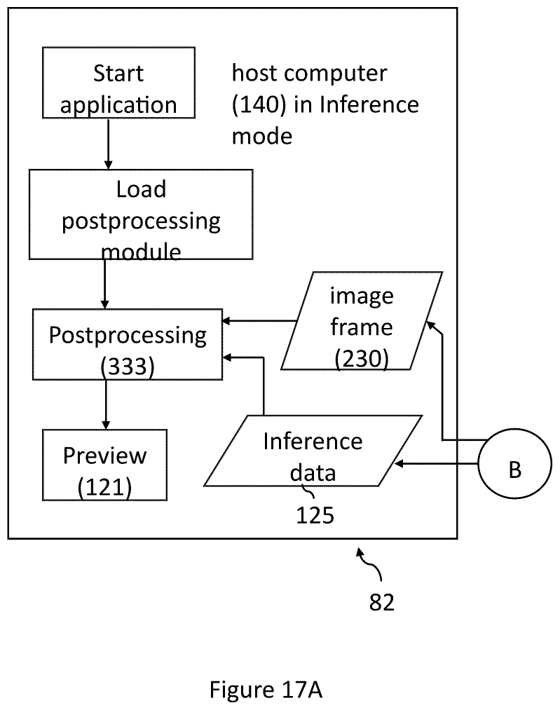

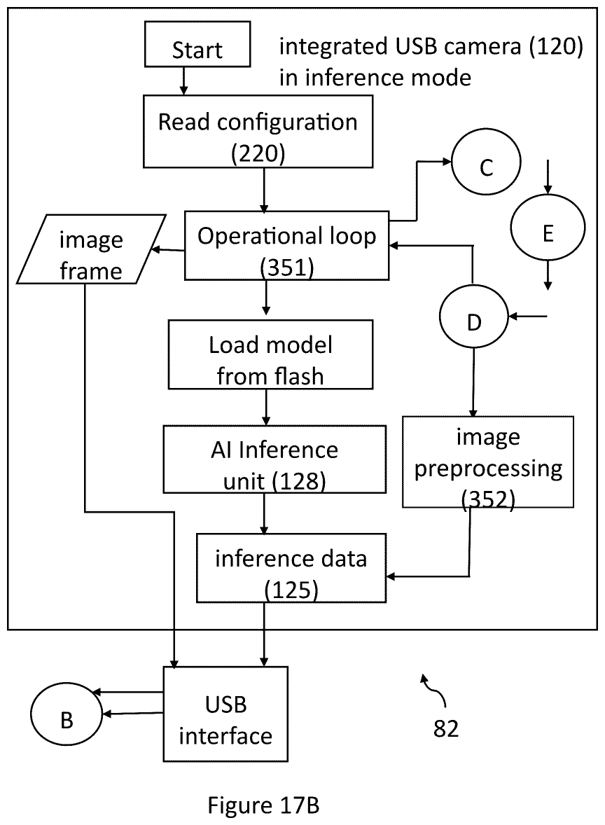

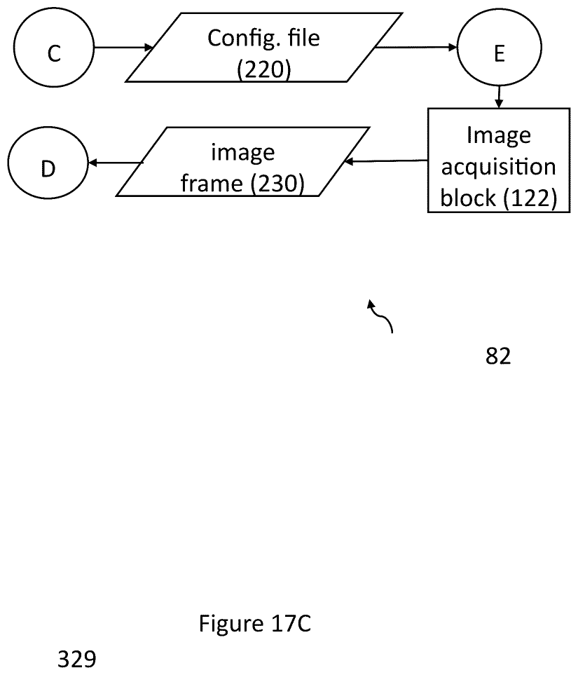

FIGS. 17A-17C referred in continuation, user selects the inference mode (82) to get desired outcome as per prescribed pre-trained model uploaded in the configuration mode (81) through the operational loop (351) running in the microcontroller (126). Once user starts inference process, the USB communicable camera starts inferencing the image frames (230) and gives out raw model output (125) to the application.

A pre-processing (352) involving following steps is carried out in the integrated USB camera (120):
resizing the frame from the sensor to model input size, for example 960×960 image to 320×320 (model input size) image.
rescaling the image based on i_scale value in user_data from config file.
changing the colour order of the image if necessary based on colour, order value in user_data from config file.
changing the image layout based on i_layout value from config file.

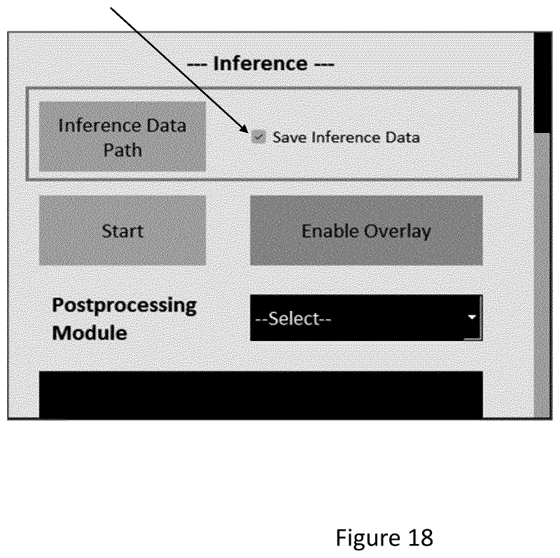

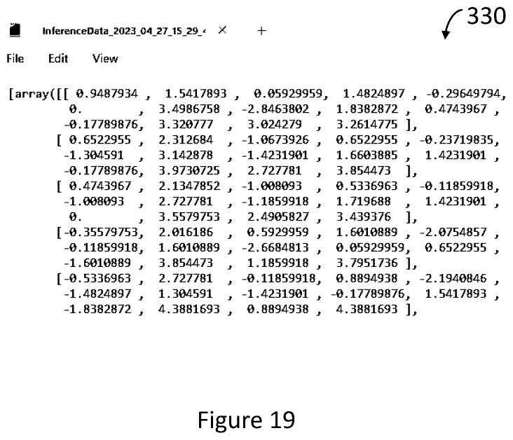

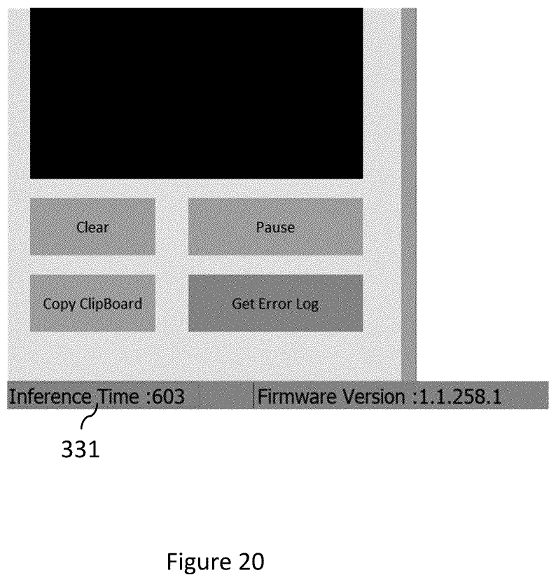

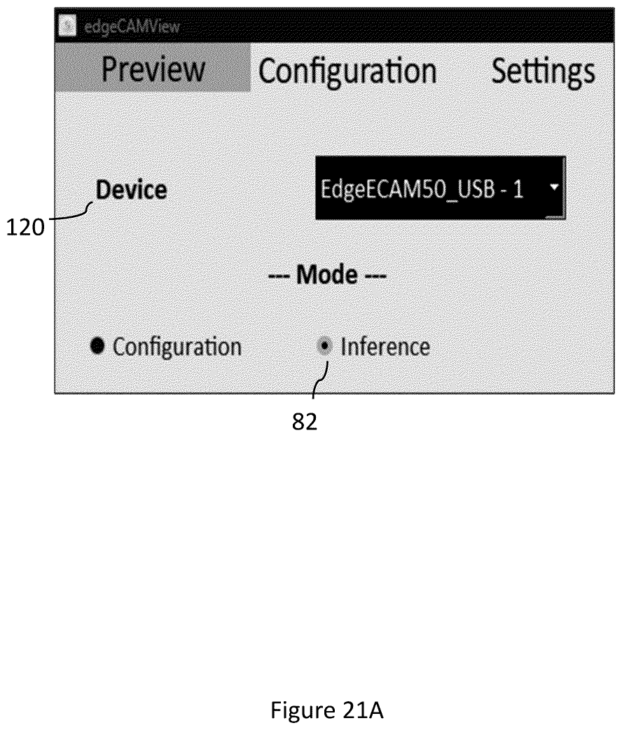

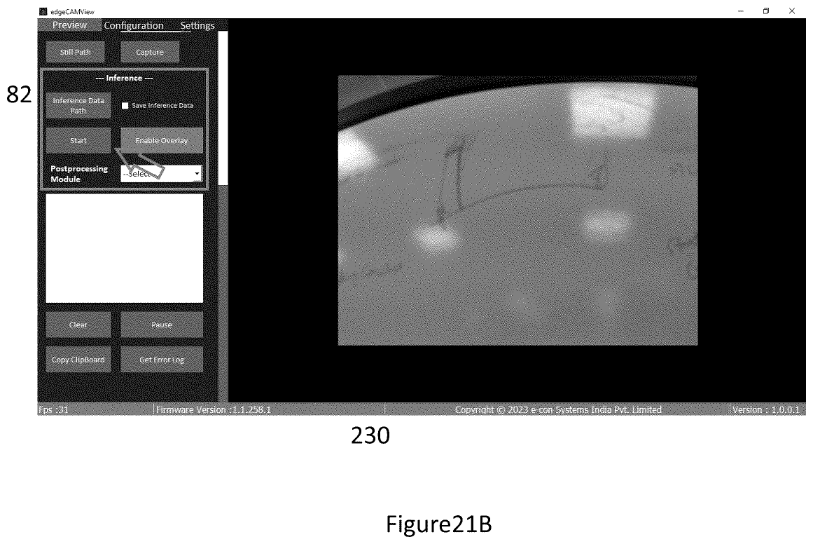

FIG. 18, this raw model output (125) is saved by the user by selecting the “save inference data” checkbox (329) and selecting the inference path before starting the inference. The saved output is the raw model output (125) from the integrated USB camera (120). FIG. 19, in a preferred embodiment, it is a python list of output tensors (330). FIG. 20, once Inference is started, the user interface application (132) shows an execution parameter of an inference time (331) taken by system (100) in mS, signifying speed of the execution of the present edge-based invention.

FIG. 21A, in inference mode (82), the device, which is the integrated USB camera (120) has only one resolution enumerated which will be the Custom resolution 1. Internally, Custom resolution 2 will be given to the model for inferencing. In this mode, user can start/stop inference if model is loaded. User can enable overlay and see the output on the application if the post processing module is selected. Rest of the features in the application would be inactive. Default will be 960×960p. Y8 at 12 fps.

FIG. 21B, on starting inference mode (82), the integrated USB camera (120) starts inferencing the image frame(s) (230) and gives out the raw model output (125) to the user interface application (132).

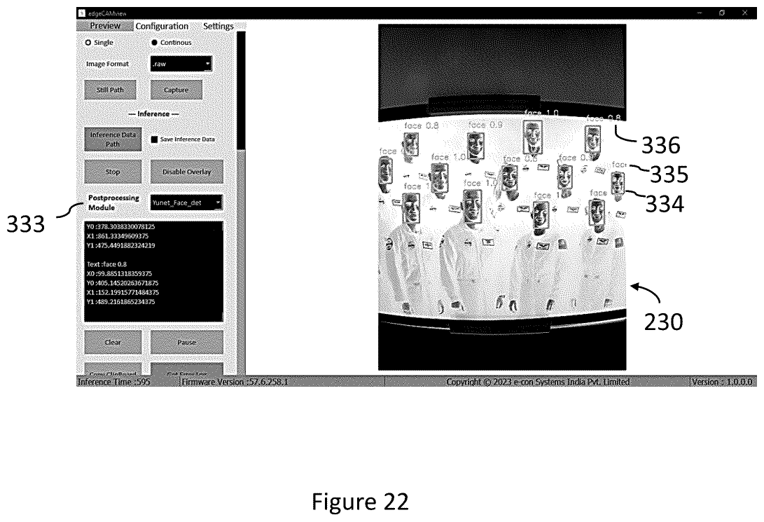

FIG. 22, the post processing (333) of model implies a user interpretable output created out of intelligent but non-readable data. Post processing varies from model to model. To overlay the raw model output (125) with a post processing framework on the preview (121) the output gets post processed into meaningful data such as bounding boxes, labels, scores. The raw model output (125) from the USB communicable camera is given to a selected post processing module and overlayed by bounding boxes (334), labels (335), scores (336) according to the task, illustratively Detection, Regression, Classification.

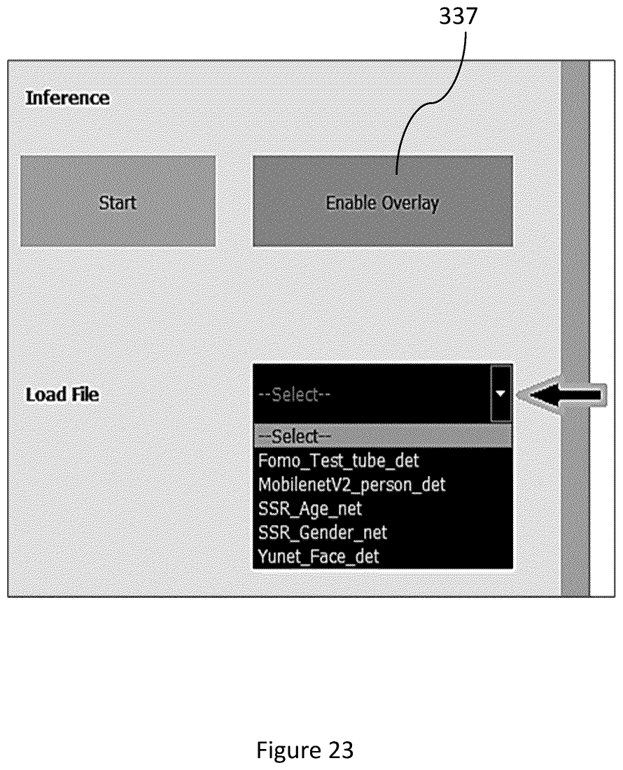

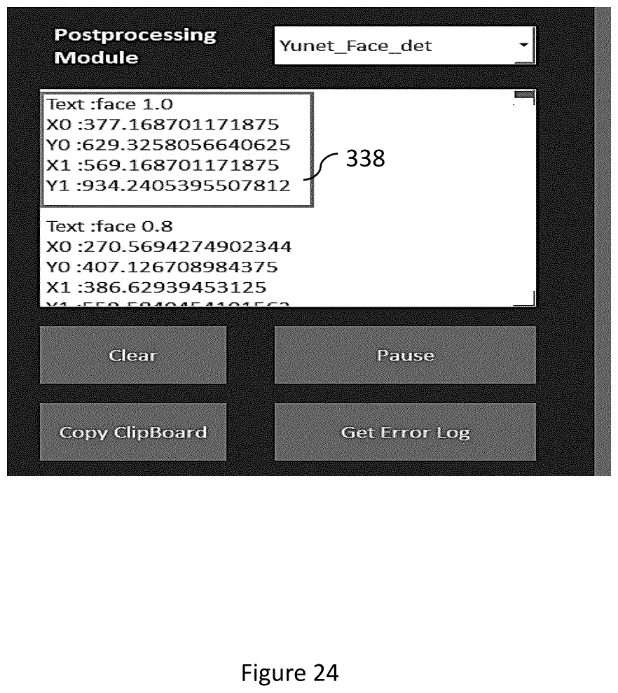

FIG. 23, by “enable overlay” (337) option applied on any selected file of the raw model output (125), user can draw a visual overlay (344) on the host computer that is based on the outputs of the loaded model, utilizing a post-processing script. This inventive feature as per the present invention which is elaborately configurable is particularly useful in verifying the accuracy and usability of the model in its target environment. With the overlay, user can see the model's detections in real-time. This way, user can ensure that the model meets specific needs and requirements.

FIG. 24, co-ordinates of detection (338) or output of the post processing script are displayed in the text box that facilitates objectively relating to corresponding image frame (230).

Customized post-processing module allows users to overlay the model output of one's own model with the user interface application (132) of the system (100).

FIG. 1, 2, 3, FIGS. 5A-5B, FIGS. 17A-17C, a configuration and inference computer program residing in the microcontroller of the integrated USB camera (120) and the processor (136) of the host computer (140), corresponding to the user interface application (132) residing in the host computer (140), is executed comprising the steps of:
a) Uploading a prescribed pre-trained machine learning model (210) to the user interface application (132)
b) Inputting through the user interface application (132) a plurality of configurable parameters including model data, region of interest data, user data
c) Generating a configuration file (220) in a protobuf format
d) Saving the configuration file (220) and the pre-trained machine learning model (210) to the flash memory (130) of the USB communicating camera
e) Rebooting or resetting (349) the USB communicating camera causing the pre-trained machine learning model (210) and the configuration file (220) get updated in the inference unit
f) Receiving image frames (230) from the sensor (123) of the USB communicating camera
g) Preprocessing (352) the image frame (230) in the inference unit
h) Running model inference on a pre-processed frame.
i) Outputting a raw model output (125) to a post processing model on the host computer (140)
j) Drawing an overlay according to a user defined post processing script (348)
k) Displaying a preview (121)

The configuration file (220) can be edited manually outside the application, provided the values are within the range mentioned in the Ranges/Limits section which can be loaded in the application later as well. This allows the user to customize various settings related to the preview (121), model input/output dimensions, memory limit, quantization, and normalization of input data.

During the inference mode, if the model size and the tensor arena size is less than available space in RAM, then the model is copied to RAM memory and model is ran from RAM. The advantage of this is that the model would inference faster when compared to model ran from Flash memory itself.

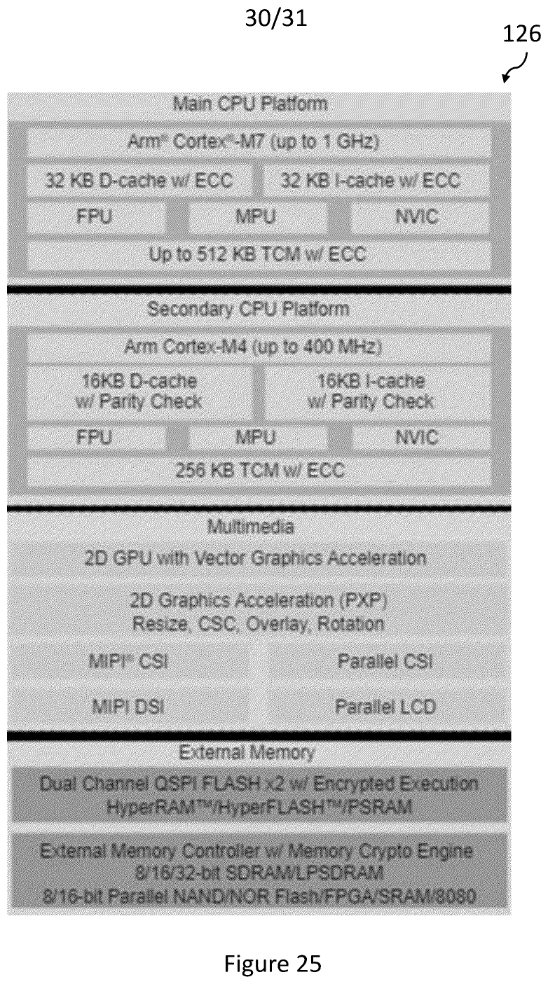

FIG. 25, the microcontroller (126) has at least a main CPU platform, a secondary CPU platform, a multimedia and an external memory, with contemporary system controls and connectivity.

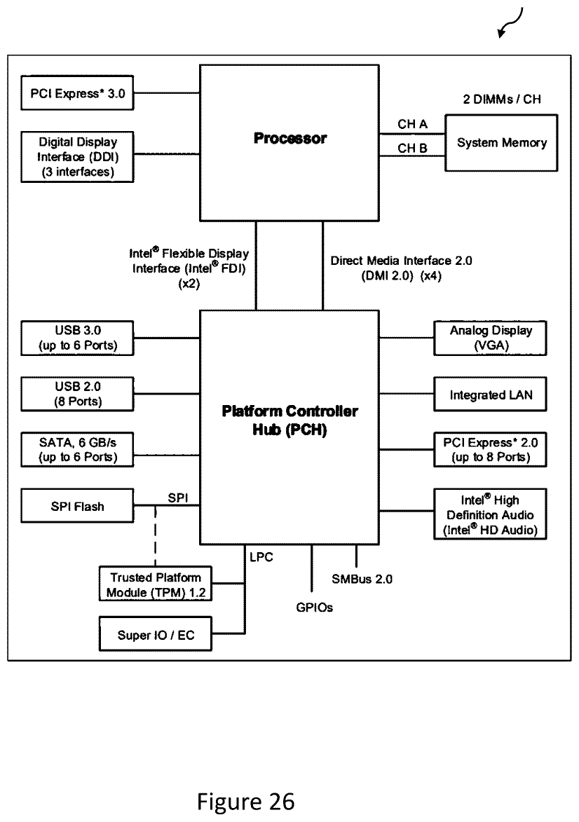

FIG. 26, the processor (136) is an INTEL® i5 processor or equivalent.

The invention claimed is:

1. A system of a universal serial bus (USB) communicating camera comprising:
an integrated USB camera with a sensor and an image signal processor, integrated with a microcontroller having an image processing module, an inference unit, a first USB interface, and a flash memory,
a host system with a processor, a user interface application and a second USB interface to communicate to and from the integrated USB camera,
the system is user configurable for application specific pre-trained machine learning models and inferencing captured frames.

2. The system of the USB communicating camera as claimed in claim 1, wherein the microcontroller of the integrated USB camera and the processor of the host computer execute the user interface application by a configuration and inference computer program.

3. The system of the USB communicating camera as claimed in claim 1, wherein the user interface application is adapted to receive an application specific configuration data by a user.

4. The system of the USB communicating camera as claimed in claim 3, wherein the application specific configuration data is converted to a protocol buffer (protobuf) file that associates data types with field names, using integers to identify each field.

5. The system of the USB communicating camera as claimed in claim 1, wherein the inference unit is an artificial intelligence inference unit that draws inference on an image frame based on an input and the corresponding pre-trained machine learning model and the application specific configuration of the integrated USB camera.

6. The system of the USB communicating camera as claimed in claim 1, wherein the microcontroller of the integrated USB camera sends a raw model output to the host system for post processing.

7. The system of the USB communicating camera of claim 1, deploys edge computing.

8. The system of the USB communicating camera as claimed in claim 1, wherein the flash memory of the integrated USB camera has a firmware residing therein that supports different application specific pre-trained machine learning models with correspondingly different configuration data co-residing therein.

9. The system of the USB communicating camera as claimed in claim 8, wherein the firmware remains unchanged when different application specific pre-trained machine learning models are uploaded in the flash memory.

10. The system of the USB communicating camera as claimed in claim 1, wherein the host system sends a different application specific pre-trained model with the correspondingly different configuration data and wherein the integrated USB camera is rebooted to infer captured frames based on a different input of the different application specific pre-trained model.

11. The system of the USB communicating camera of claim 1 has a configuration mode and an inference mode, wherein, the configuration mode enables a user based configuration for different application specific pre-trained machine learning models, while the inference mode enables a corresponding raw model output generation from the inference unit and a post processing of the raw model output by the host system.

12. The system of the USB communicating camera as claimed in claim 10, wherein the configuration mode is adapted to provide options of a resolution setting including a custom resolution setting, with a default resolution setting.

13. The system of the USB communicating camera as claimed in claim 10, wherein the configuration mode is adapted to select video capturing formats and still picture capturing formats including one of a single still capture and a continuous still capture.

14. The system of the USB communicating camera as claimed in claim 10, wherein the configuration mode is adapted to set or limit a region of interest (ROI).

15. The system of the USB communicating camera as claimed in claim 14, wherein the ROI having a different aspect ratio of a ROI width and a ROI height adapts to an aspect ratio of the custom resolution.

16. The system of the USB communicating camera as claimed in claim 10, wherein the inference mode is adapted to trigger the integrated USB camera start inferencing the frames and output raw model to the user interface application.

17. The system of the USB communicating camera as claimed in claim 10, wherein the raw model output is sent from the integrated USB camera to the host system as data packets.

18. The system of the USB communicating camera as claimed in claim 17, wherein the raw model output is a python list of output tensors.

19. The system of the USB communicating camera as claimed in claim 10, wherein the inference mode is adapted to trigger on the host system a post processing of raw model into interpretable data including bounding boxes, labels, scores.

20. A configuration and inference computer program and a corresponding user interface application, residing in a system of a universal serial bus (USB) communicating camera, comprising
an integrated USB camera with a sensor and an image signal processor, integrated with a microcontroller having an image processing module, an inference unit and a USB interface, and a flash memory,
a host system with a processor, a user interface application and a USB interface to communicate to and from the integrated USB camera,
the configuration and inference computer program and the corresponding user interface application is executed comprising the steps of:
a) Uploading a prescribed pre-trained machine learning model to the user interface application
b) Inputting through the user interface application a plurality of configurable parameters including model data, region of interest data, user data
c) Generating a configuration file in a protocol buffer format
d) Saving the configuration file and the model to the flash memory of the integrated USB camera
e) Rebooting the integrated USB camera causing the model and the configuration file get updated in the inference unit
f) Receiving frames from the sensor of the integrated USB camera
g) Preprocessing the frame in the inference unit
h) Running model inference on a pre-processed frame
i) Sending a raw model output to a post processing model residing on the host system
j) Drawing an overlay according to a user defined post processing script
k) Displaying a preview
